(19) United States
(12) Patent Application Publication
(10) Pub. No.: US 2005/0118342 A1
(43) Pub. Date: Jun. 2, 2005

(54) Process for depositing a catalyst

(76) Inventors: Manfred Engelhardt, Feldkirchen-Westerham (DE); Gernot Steinlesberger, Munchen (DE); Eugen Unger, Augsburg (DE)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 10/980,011

(22) Filed: Nov. 3, 2004

(30) Foreign Application Priority Data
Nov. 3, 2003 (DE) 103 51 230.6

(51) Int. Cl. B05D 3/02

(52) U.S. Cl. 427/372.2; 427/430.1

(57) ABSTRACT

A process for the selective and areal deposition of a catalyst is disclosed, which is intended for the growth of nanotubes, on an interconnect line in an integrated circuit or chip. The process includes providing an acidic or alkaline aqueous solution of the catalyst; applying the solution to the interconnect line; and removing the excess solution.

### CROSS-REFERENCE TO RELATED APPLICATIONS

This Utility Patent Application claims priority to German Patent Application No. DE 103 51 230.6, filed on Nov. 3, 2003, which is incorporated herein by reference.

### FIELD OF THE INVENTION

The present invention relates to a process for the selective and areal deposition of a catalyst intended for the growth of nanotubes.

### BACKGROUND

Nanotubes, in particular carbon nanotubes, are suitable for use as metallic conductors and as semiconductors in nano-electronics. The integration of nanotubes, in particular carbon nanotubes, in integrated circuits as an alternative to a metallization according to the prior art is disclosed, for example, in “Microelectron. Eng.” 2002, 64, pages 399-408 and in “Nano Lett.” 2003, 3, pages 257-239.

Catalysts are required for the growth of nanotubes, for example in a chemical vapor deposition (CVD) process. The catalysts used are in particular iron as well as cobalt and nickel.

It is generally known to deposit catalysts by sputtering or evaporation coating. However, the deposition is in this case not carried out selectively only on the corresponding interconnect line. Moreover, in the case of deposition in hole structures, not only is the base of the hole insufficiently covered with the catalyst over its area, but also the catalyst is deposited at the trench wall, which leads to undesired growth of the nanotubes from the trench wall. In the least favorable scenario, there will be no catalyst at all deposited on the interconnect at the base of the trench. The absence of growth of the nanotubes on the interconnect line then means that the conductive or semiconducting connection between this interconnect line and the next metal level is not produced.

### SUMMARY

Embodiments of the invention provide a process for depositing a catalyst, intended to grow nanotubes, in an integrated circuit.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated, as they become better understood by reference to the following detailed description. The elements of the drawings are not necessarily to scale relative to each other. Like reference numerals designate corresponding similar parts.

FIG. 1 illustrates a resist patterning for producing a mask for the subsequent hole etch, in one embodiment of a process according to the invention.

FIG. 2 illustrates a hole etch for contact-connection to the metal level below, in one embodiment of a process according to the invention.

FIG. 3 illustrates one embodiment where the uncovered metal layer of the lower metal level has been exchanged for the catalyst material in accordance with the invention at the base of the trench.

FIG. 4 illustrates one embodiment of selective growth of the carbon nanotubes starting from the catalyst layer that has been produced, the projecting carbon nanotubes then being removed and the surface planarized.

FIG. 5 illustrates one embodiment of the upper metal level; the dielectric is deposited and patterned.

FIG. 6 illustrates one embodiment of the upper metallization being carried out.

In the drawings: A . . . e.g. Al b . . . e.g. Ta K . . . e.g. Fe a . . . e.g. TiN c . . . e.g. Ti, Ta B . . . e.g. Cu X . . . e.g. SiO₂

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention provides a process which overcomes the drawbacks of the prior art.

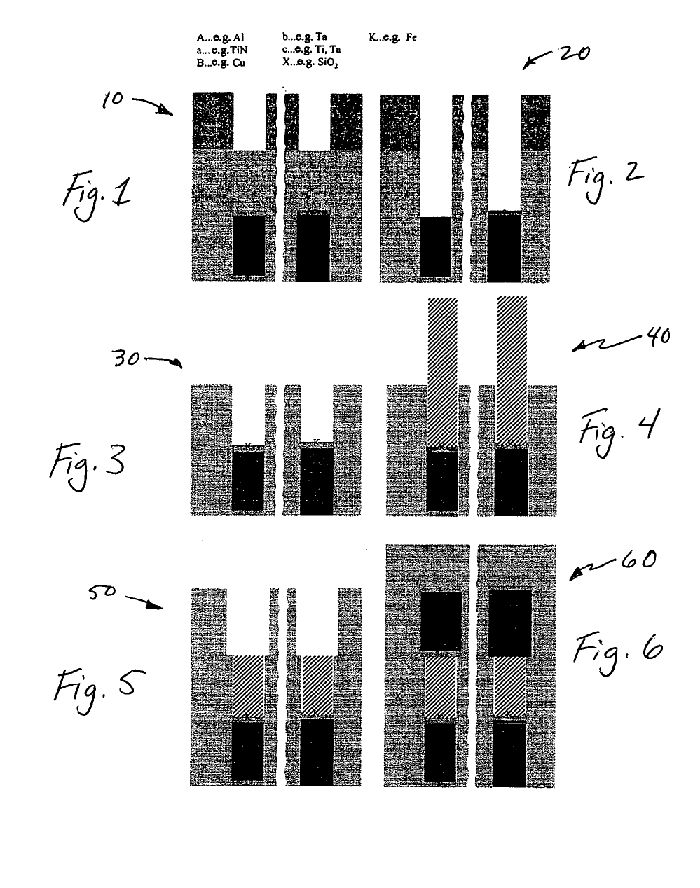

FIGS. 1 to 6 illustrate the deposition of catalyst for the contact-connection of two metal levels using carbon nanotubes for two different forms of metallization (left-hand trench: aluminum metallization; right-hand trench: copper metallization; Damascene technique used in both cases; a subtractive method, i.e. deposition of Al over the entire area followed by the formation of line and hole structures by reactive ion etching of Al, is also conceivable for aluminum).

FIGS. 1 to 6 illustrate two embodiments of the process according to the invention, which are explained in more detail below.

The present invention provides a process for the selective and areal deposition of a catalyst, which is intended for the growth of nanotubes, on an interconnect line in an integrated circuit, comprising:
a) providing an acidic or alkaline aqueous solution of the catalyst,
b) applying the solution to the interconnect line, and
c) removing the excess solution.

As a result of the process according to the invention, the catalyst is deposited selectively and areally on the interconnect line as a result of a redox reaction between the acidic or alkaline aqueous solution of the catalyst and the interconnect line. In particular, the process according to the invention allows selective and areal catalyst deposition, via open via structures, on the interconnect line arranged below. In particular, the process according to the invention also allows selective and areal deposition of catalyst at the bottom of the via or trench bottom.

In a) of the process according to the invention, first of all an acidic or alkaline aqueous solution of the catalyst is provided. The standard potential of the dissolved catalyst must be greater than the standard potential of the metal of the interconnect line, so that in a redox reaction the metal of the interconnect line is dissolved and the catalyst which is present in solution is deposited in elemental form. By way of example, in this way aluminum atoms of the top layers of an aluminum interconnect line are exchanged for iron atoms which, depending on the process parameters for the growth of nanotubes also with the participation of aluminum, form a catalyst layer.

Al and Fe, and also Ta and Ni, form preferred redox system pairs.

In b) of the process according to the invention, the acidic or alkaline aqueous solution of the catalyst is applied to a chip or a wafer by, for example, the chip or wafer being immersed in the solution. The immersion means that aqueous solution of the catalyst is also applied to interconnect lines which have open surfaces as a result of the via patterning.

In c) of the process according to the invention, the excess solution is removed by first rinsing and then drying. Rinsing is preferably carried out using first water and then an alcohol, for example isopropyl alcohol. Drying is then carried out in an inert gas stream, for example in a stream of nitrogen.

The process according to the invention can be used for any selective and areal deposition of thin metallic layers in structures with a high aspect ratio if the metals involved in each case have suitable standard redox potentials.

The integration of nanotubes, in particular of carbon nanotubes for filling vias between, for example, two aluminum metal levels, is realized in such a way that the process according to the invention can be integrated in production lines. For this purpose, in a wet-chemical process aluminum is replaced, preferably by iron, at the location from which the connection to the next metal level up is to be produced through the via. This layer of iron, which is formed only at the uncovered locations of the aluminum interconnect, but not beneath the patterned insulator (SiO₂), serves as a catalyst in the subsequent nanotube growth process, for example in a chemical vapor deposition process.

Surprisingly, the process according to the invention allows the known sputtering or evaporation coating process, which leads to a non-areal and nonselective deposition of a catalyst intended for the growth of nanotubes, in particular carbon nanotubes, on an interconnect line in an integrated circuit, to be replaced by an inexpensive wet-chemical process.

A patterned passivation layer, which may be required in the case of a copper metallization, is likewise replaced, preferably by nickel. It is preferable for tantalum- or titanium-based redox systems to be used for passivation layers which cover exclusively the copper trenches.

FIG. 1 illustrates a resist patterning for producing a mask for the subsequent hole etch, in one embodiment of a process according to the invention at 10. FIG. 2 illustrates a hole etch for contact-connection to the metal level below, in one embodiment of a process according to the invention at 20. FIG. 3 illustrates one embodiment where the uncovered metal layer of the lower metal level has been exchanged for the catalyst material in accordance with the invention at the base of the trench at 30. FIG. 4 illustrates one embodiment of selective growth of the carbon nanotubes starting from the catalyst layer that has been produced, the projecting carbon nanotubes then being removed and the surface planarized at 40. FIG. 5 illustrates one embodiment of the upper metal level, the dielectric is deposited and patterned at 50. FIG. 6 illustrates one embodiment of the upper metallization being carried out at 60.

Advantageous embodiments of the invention are explained in more detail in the examples which follow.

### EXAMPLE 1

1.5 g of iron(II) chloride (FeCl₂×4 H₂O) are dissolved in 20 ml of H₂O and added to 25 ml of concentrated phosphoric acid. The solution obtained in this way is then applied to the aluminum interconnect lines at approximately 30° C. Then, the chip is rinsed with water and isopropyl alcohol and dried in a stream of nitrogen.

### EXAMPLE 2

When working in an alkaline medium, 1.5 g of iron(II) chloride and 4.5 g of sodium tricitrate are dissolved in 100 ml of H₂O and a pH of approximately 10 is established using ammonia or sodium hydroxide solution. This solution is then applied to the aluminum interconnect lines at approximately 70° C. Then, the chip is rinsed with water and isopropyl alcohol and dried in a stream of nitrogen.

### EXAMPLE 3

If Ni is to be deposited as catalyst on a Ta-passivated copper interconnect line, the procedure is to be the same as described in Example 1, except that semi-concentrated hydrofluoric acid is used instead of concentrated phosphoric acid.

In the examples, small quantities of elemental catalyst are deposited selectively and areally on the metallization, i.e., on the interconnect, within a few minutes.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A process for the selective and areal deposition of a catalyst, which is intended for the growth of nanotubes, on an interconnect line in an integrated circuit by means of a redox reaction between the acidic or alkaline aqueous solution of the catalyst and the interconnect line, comprising:
providing the acidic or alkaline aqueous solution of the catalyst,
applying the solution to the interconnect line, and
removing the excess solution.

2. The process of claim 1, in which Fe is provided in an acidic solution.

3. The process of claim 1, in which Fe is provided in an alkaline solution.

4. The process of claim 1, in which Ni is provided in an acidic solution.

5. The process of claim 1, in which Ni is provided in an alkaline aqueous solution.

6. The process of claim 1, in which the solution is applied to an interconnect line formed from at least one of Al, Cu or Ta-passivated Cu.

7. The process of claim 1, comprising removing the excess solution by rinsing and then drying.

8. A process comprising:
providing the acidic or alkaline aqueous solution of the catalyst,
applying the solution to the interconnect line, and
removing the excess solution; for the selective and areal deposition of a catalyst, which is intended for the growth of nanotubes, on an interconnect line in an integrated circuit by means of a redox reaction between the acidic or alkaline aqueous solution of the catalyst and the interconnect line.

9. The process of claim 8, in which Fe is provided in an acidic solution.

10. The process of claim 8, in which Fe is provided in an alkaline solution.

11. The process of claim 8, in which Ni is provided in an acidic solution.

12. The process of claim 8, in which Ni is provided in an alkaline aqueous solution.

13. The process of claim 8, in which the solution is applied to an interconnect line formed from at least one of Al, Cu or Ta-passivated Cu.

14. The process of claim 13, comprising removing the excess solution by rinsing and then drying.

15. A process for making a chip comprising:
providing the acidic or alkaline aqueous solution of the catalyst,
applying the solution to the interconnect line, and
removing the excess solution; for the selective and areal deposition of a catalyst, which is intended for the growth of nanotubes, on an interconnect line in an integrated circuit by means of a redox reaction between the acidic or alkaline aqueous solution of the catalyst and the interconnect line.

16. The process of claim 15, in which Fe is provided in an acidic solution.

17. The process of claim 15, in which Fe is provided in an alkaline solution.

18. The process of claim 15, in which Ni is provided in an acidic solution.

19. The process of claim 15, in which Ni is provided in an alkaline aqueous solution.

20. The process of claim 15, in which the solution is applied to an interconnect line formed from at least one of Al, Cu or Ta-passivated Cu.

21. The process of claim 20, comprising removing the excess solution by rinsing and then drying.

22. A process for making a chip comprising:
means for providing the acidic or alkaline aqueous solution of the catalyst,
means for applying the solution to the interconnect line, and
means for removing the excess solution; for the selective and areal deposition of a catalyst, which is intended for the growth of nanotubes, on an interconnect line in an integrated circuit by means of a redox reaction between the acidic or alkaline aqueous solution of the catalyst and the interconnect line.
